(19) United States
(12) Patent Application Publication
(10) Pub. No.: US 2010/0257182 A1
(43) Pub. Date: Oct. 7, 2010

(54) AUTOMATED DYNAMIC STYLE GUARD FOR ELECTRONIC DOCUMENTS

(75) Inventors: Bassam Saliba, Sammamish, WA (US); John Yii, Newcastle, WA (US); Piotr Lukaszuk, Redmond, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Equiom Labs LLC, Bellevue, WA (US)

(21) Appl. No.: 12/754,488

(22) Filed: Apr. 5, 2010

Related U.S. Application Data
(60) Provisional application No. 61/166,870, filed on Apr. 6, 2009.

(51) Int. Cl. G06F 17/30; G06N 5/02

(52) U.S. Cl. 707/747; 706/47; 707/E17.052

(57) ABSTRACT

Techniques for checking content for style. Content that identifies a rule set is identified. The rule set includes rules of differing scope. The scope for some rules may be paragraph scope while the scope for other rules may be document scope. Conditions of rules of the rule set having differing scopes are checked. When conditions for one or more of the rules are met, actions specified for corresponding rules are performed. Users may be provided tools for creating or customizing rules.

### CROSS-REFERENCES TO RELATED APPLICATIONS

The present invention claims the benefit of priority under 35 U.S.C. §119(e) of U.S. Provisional Application No. 61/166,870, filed Apr. 6, 2009, the entire content of which is incorporated herein by reference.

### BACKGROUND OF THE INVENTION

In many contexts, adherence to one or more sets of stylistic rules is required, or at least desirable, when writing or otherwise creating content, such as press releases, documents, or other content. Writing in certain academic contexts may adhere to certain conventions while journalistic and other writing may utilize others. The stylistic rules may be related to a variety of aspects of content, such as how and when abbreviations may be used, how and when colloquialisms may be used, when symbols may be used to replace other content, how measurements should be presented, how captions for pictures and/or video should appear, how citations should be formatted, and generally, any aspect of content.

Typically, writers memorize applicable stylistic rules and, when in doubt, refer to one or more style books and/or instances of content on the Internet. Referencing a style book or internet content may involve a process of searching an index or table of contents for applicable rules, reading several potentially applicable rules, and manually editing content in order to comply with any identified applicable rules. Not only can such a process be tedious, but writers may not be aware that certain portions of their content implicate stylistic rules and, therefore, violations of rules may go unnoticed. In contexts where deadlines require quick creation of content, the extent of stylistic rule violations may be exacerbated due to the rapid pace of developing and publishing content.

### BRIEF SUMMARY OF THE INVENTION

Embodiments of the present invention provide techniques for automated style checking. In one embodiment, a computer-implemented method of checking content is disclosed. The method may be performed under the control of one or more computer systems configured with executable instructions and may include identifying a portion of the content that implicates a rule set, where the rule set includes one or more first rules having first scope and one or more second rules has second scope. In an embodiment, the second scope is larger than the first scope. For a first rule of the rule set, a determination is made whether a first subset of the content meets one or more first conditions for the first rule, where the first subset is in accordance with the first scope and includes the portion. For a second rule of the rule set, a determination is made whether a second subset of the content meets one or more second conditions for the second rule, where the second subset is in accordance with the second scope. When the first subset meets the one or more first conditions, one or more first actions specified for the first rule is performed. When the second subset meets the one or more second conditions, one or more second actions specified for the second rule is performed.

In an embodiment, the first scope is paragraph scope, and the second scope is document scope. The first scope may be word scope while the second scope may be sentence scope. Generally, in an embodiment, the first scope and second scope may be any scope suitable for any particular application. Also, in an embodiment, the first scope is smaller than and contained within the second scope. The method may further include identifying potentially changed portion of the content and selecting the portion of the content that implicates the rule set from the potentially changed portion of the content. Selecting the portion of the content that implicates the rule set may include, for each of one or more divisions of the potentially changed portion of the content, calculating a hash value for the division and determining whether the hash value exists in a hash table of processed sections. The method may also include repeating the method for a plurality of rule sets. A rule set may include at least one rule encoded by one or more regular expressions and/or at least one rule encoded in a scripting language.

In another embodiment, a computer-readable storage medium having stored thereon instructions for causing one or more processors to check content for style is described. The instructions may include instructions that cause the one or more processors to identify a portion of the content that implicates a rule set, the rule set including one or more first rules having first scope and one or more rules having second scope, the second scope being larger than the first scope; instructions that cause the one or more processors to, for a first rule of the rule set, determine whether a first subset of the content meets one or more first conditions for the first rule, the first subset being in accordance with the first scope and including the portion; instructions that cause the one or more processors to, for a second rule of the rule set, determine whether a second subset of the content meets one or more second conditions for the second rule, the second subset being in accordance with the second scope; instructions that cause the one or more processors to, when the first subset meets the one or more first conditions, perform one or more first actions specified for the first rule; and instructions that cause the one or more processors to, when the second subset meets the one or more second conditions, perform one or more second actions specified for the second rule.

The first scope may be paragraph scope, and the second scope may be document scope. The first scope may be word scope while the second scope may be sentence scope. Generally, in an embodiment, the first scope and second scope may be any scope suitable for any particular application. Also, in an embodiment, the first scope is smaller than and contained within the second scope. The instructions may further comprise instructions that cause the one or more processors to identify potentially changed portion of the content, and select the portion of the content that implicates the rule set from the potentially changed portion of the content. The instructions that cause the one or more processors to select the portion of the content that implicates the rule set may include, instructions that cause the one or more processors to, for each of one or more divisions of the potentially changed portion of the content, calculate a hash value for the division; and instructions that cause the one or more processors to determine whether the hash value exists in a hash table or processed sections. The instructions may also include instructions that cause the one or more processors to repeat the method for a plurality of rule sets. The rule set may include at least one rule encoded by one or more regular expressions and/or at least one rule encoded in a scripting language.

In yet another embodiment, a system for checking content for style is disclosed. The system includes a data store having stored therein a rule set that includes one or more first rules having first scope and one or more second rules having second scope, the second scope being larger than the first scope. The system also includes one or more processors communicatively coupled with the data store and operable to identify a portion of the content that implicates a rule set, the rule set including one or more first rules having first scope and one or more rules having second scope, the second scope being larger than the first scope; for a first rule of the rule set, determine whether a first subset of the content meets one or more first conditions for the first rule, the first subset being in accordance with the first scope and including the portion; for a second rule of the rule set, determine whether a second subset of the content meets one or more second conditions for the second rule, the second subset being in accordance with the second scope; when the first subset meets the one or more first conditions, perform one or more first actions specified for the first rule; and when the second subset meets the one or more second conditions, perform one or more second actions specified for the second rule.

The first scope may be paragraph scope and the second scope may be document scope. The first scope may be word scope while the second scope may be sentence scope. Generally, in an embodiment, the first scope and second scope may be any scope suitable for any particular application. Also, in an embodiment, the first scope is smaller than and contained within the second scope. The one or more processors may be further operable to identify potentially changed portion of the content and select the portion of the content that implicates the rule set from the potentially changed portion of the content. Also, the one or more processors may be further operable to, for each of one or more divisions of the potentially changed portion of the content, calculate a hash value for the division; and determine whether the hash value exists in a hash table of processed sections. In addition, the one or more processors may be operable to repeat the method for a plurality of rule sets. The rule set may include at least one rule encoded by one or more regular expressions and/or at least one rule encoded in a scripting language.

The foregoing, together with other features and embodiments, will become more apparent upon referring to the following specification, claims, and accompanying drawings.

### BRIEF DESCRIPTION OF THE DRAWINGS

FIG. 1 is a simplified block diagram of a computer system 100 that may be used to practice embodiments of the present invention.

FIG. 2 is a block diagram of an environment which may be used to practice various embodiments of the present invention.

FIG. 3 is an example interface page for an interface presented in accordance with an embodiment.

FIG. 4 shows a process for checking style in accordance with an embodiment.

FIG. 5 shows a process for processing rules to determine compliance of content with the rules in accordance with an embodiment.

FIG. 6 is an example interface page for creating rules that can be used in connection with various embodiments.

### DETAILED DESCRIPTION OF THE INVENTION

Embodiments of the present invention relate to an automated style guard. In an embodiment, style guard is a tool, which may be implemented as a plug-in for a word processing or other content editing software, that encodes rules from any number of writing style guides and implements an algorithm that executes these rules within any electronic system that accepts input. For example, a style guard may be an add-on to desktop-based word processing applications, including Microsoft Word® for Windows® and the Mac®, and other applications. A style guard may analyze a whole document and portions thereof, such as sentences and/or paragraphs, using hierarchical logic. A user interface may provide a straight-forward user experience in which appropriate recommendations in accordance with the rules and criteria of the guide are provided. The rules and criteria may range from simple abbreviations to more complex corrections addressing fractions, dates, titles, and the like. A style guard tool may be designed to accept multiple and different set of guidelines and rules. Guidelines and rules may be incorporated into a standard XML format with an arbitrary number of rules for any single style, although other ways of encoding guidelines and rules may be used. Rules can have one or more scopes. For instance, a rule may apply locally within a word, sentence, paragraph, chapter, section, page, or across a whole document or other collection of content. Users, in an embodiment, are able to define their own rules and are able to update the set of rules periodically using the Internet or other suitable communications network. Users may also be able to use the same set of rules to look up style guidelines on a mobile device.

Typically, writers check whether their document, press release, or other writing conforms to a given style or set of styles by memorizing what they think are relevant styles. When in doubt, writers generally refer to a style book or to appropriate content on the Internet. Word processors and other electronic systems generally do not notify writers that a style guide applies to a section of text.

In an embodiment, a style guard may be implemented as an add-in to a word processing, spreadsheet, presentation, electronic mail, or other application. Examples of applications in which a style guard may work include Microsoft Office® applications, including Word®, Outlook®, PowerPoint®, Excel®, and other office suites or individual applications therein. For example, a user may download and install a style guard add-in on a personal computing device executing a word processing or other application. When the application is started, the application may start the style guard add-in. The add-in may then create a side pane display that provides basic information about the current open document. The add-in may also “hook” into the keystroke or other input events of the application. In some embodiments, such as with some applications where it is not possible to hook the keyboard input, the add-in may set a time that fires periodically (for example every 1-2 seconds). For example, a style guard add-in may periodically query an application for current content, new content, or otherwise. Therefore, a process to analyze the document for style matches may be initiated periodically, each time the user enters a keystroke, and/or otherwise. An analytical process may execute all the style rules of a given style (e.g. Associated Press (AP) style) against the document and will keep track of all matched styles and the location of the matches within the document. A matched rule may be defined as any set of text that matches a given regular expression or a script using a procedural scripting language. The side pane, in an embodiment, is then updated with a summary of the matched rules. Styles may also be classified by category and/or by importance and the user may have the option to exclude/include styles for a set of categories/importance levels. For example, the user, in an embodiment, is able to specify to only execute style rules for abbreviations with importance greater than 5. Style Guard may also create a “SmartTag” inside the document for each match. As the user navigates through the document, or should the user select a specific style smart tag, the side pane may be updated with the relevant matched style and any suggestions to better conform to the rule. If the rule defines a suggested fix, the user may be given the option to change the corresponding text in the document, to fix all matches, to ignore this rule for a given match, to ignore the rule throughout the document, to annotate the document with a comment containing the style description, and/or to perform other actions.

A style guard, in accordance with various embodiments, may be composed of several components including a set of style guides. A style guide (also referred to as a style collection), as used herein, may be a set of styles. A style may include a name, rich description (with programmable components such as calculators), a category, and importance. A style may have a set of rules. each rule is defined as a matching expression, suggested change, and additional description. the matching expressions can be, but are not necessarily, regular expressions. Expressions may also be script expressions. A suggestion expression can reference the matched expression. The additional description may provide context for that instance of the rule as it applies to the style. A style guide (meaning a set of styles and their rules) may be encoded inside an XML file or a database. An add-in may be a Component Object Model (COM) or Visio Studio Tools for Office (VSTO) add-in. The add-in may have several components, including a side panel which may embed a browser control to richly display the document and style matching statistics, as well as the style descriptions themselves. A ribbon or toolbar may enable the user to display, hide, and configure a style guard. A memory state may be initialized at application startup with the set of relevant rules. A processing engine may execute a set of style rules and algorithms each time the content is modified using an associated application. A correction engine may modify a document to reflect changes necessary to conform to a style rule. A web service may provide style updates.

Upon starting up, a hook may be set up to monitor any changes to the document being edited. A style guard may maintain a list of matches within the document. As the document is modified, this list of matches may be updated to add or remove any new matches. A match may be defined as a style identifier (id), rule id, start location, and end location within the document. In an embodiment, a style guard provides a style editing mode in which a user can navigate back and forth through a list of matches with the document. For each match, there may be a “suggested” fix, and the user may have the option to apply that fix. If the user chooses to apply a fix, the corresponding start location and end location within the document is replaced by the suggested expression after it gets evaluated. In an embodiment, the user may select an option for adding a comment to the document for that rule, and the add-in may use the application's programmable interface to create a new comment at the rules start location/end location within the document.

Thus, in various embodiments, style guard may be used to track any type of document writing style. This includes technology styles, conformance to security standards, as well as style suggestions for broadcast scripts, or any other styles. Style guard applications may be provided for hand-held devices, mobile devices, online style checking, community-based style guides and discussions, and the like.

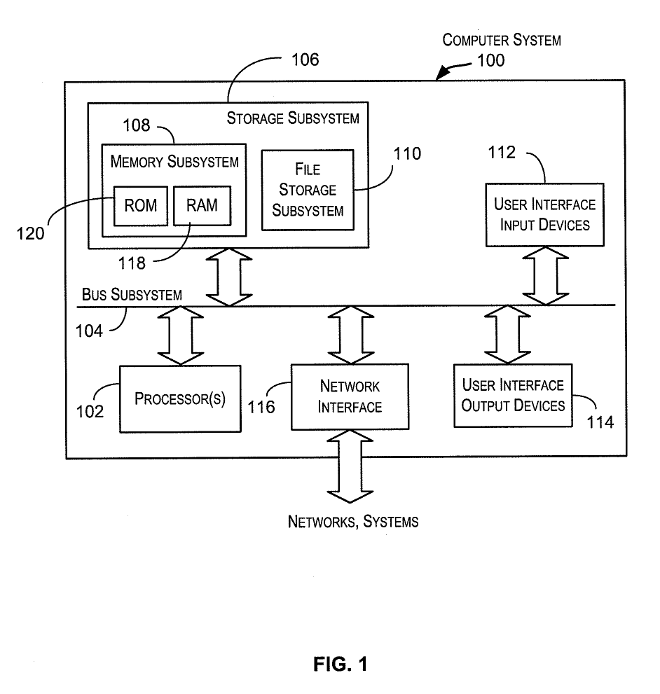

FIG. 1 is a simplified block diagram of a computer system 100 that may be used to practice an embodiment of the present invention. In various embodiments, computer system 100 may be used to implement any of the systems illustrated and described above. For example, computer system 100 may be used to implement processes for style checking according to the present disclosure. As shown in FIG. 1, computer system 100 includes a processor 102 that communicates with a number of peripheral subsystems via a bus subsystem 104. These peripheral subsystems may include a storage subsystem 106, comprising a memory subsystem 108 and a file storage subsystem 110, user interface input devices 112, user interface output devices 114, and a network interface subsystem 116.

Bus subsystem 104 provides a mechanism for enabling the various components and subsystems of computer system 100 to communicate with each other as intended. Although bus subsystem 104 is shown schematically as a single bus, alternative embodiments of the bus subsystem may utilize multiple busses.

Network interface subsystem 116 provides an interface to other computer systems and networks. Network interface subsystem 116 serves as an interface for receiving data from and transmitting data to other systems from computer system 100. For example, network interface subsystem 116 may enable a user computer to connect to the Internet and facilitate communications using the Internet.

User interface input devices 112 may include a keyboard, pointing devices such as a mouse, trackball, touchpad, or graphics tablet, a scanner, a barcode scanner, a touch screen incorporated into the display, audio input devices such as voice recognition systems, microphones, and other types of input devices. In general, use of the term “input device” is intended to include all possible types of devices and mechanisms for inputting information to computer system 100.

User interface output devices 114 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 100. Any content and markup representative of implicated style rules may be outputted by computer system 100 using one or more of user interface output devices 114.

Storage subsystem 106 provides a computer-readable storage medium for storing the basic programming and data constructs that provide the functionality of the present invention. Software (programs, code modules, instructions) that when executed by a processor, provide the functionality of the present invention may be stored in storage subsystem 106. These software modules or instructions may be executed by processor(s) 102. Storage subsystem 106 may also provide a repository for storing data used in accordance with the present invention. Storage subsystem 106 may comprise memory subsystem 108 and file/disk storage subsystem 110.

Memory subsystem 108 may include a number of memories including a main random access memory (RAM) 118 for storage of instructions and data during program execution and a read only memory (ROM) 120 in which fixed instructions are stored. File storage subsystem 110 provides a non-transitory persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Computer system 100 can be of various types, including a personal computer, a portable computer, a workstation, a network computer, a mainframe, a kiosk, a server, electronic book reader, mobile device, or any other data processing system. Due to the ever-changing nature of computers and networks, the description of computer system 100 depicted in FIG. 1 is intended only as a specific example for purposes of illustrating an embodiment of the computer system. Many other configurations having more or fewer components than the system depicted in FIG. 1 are possible.

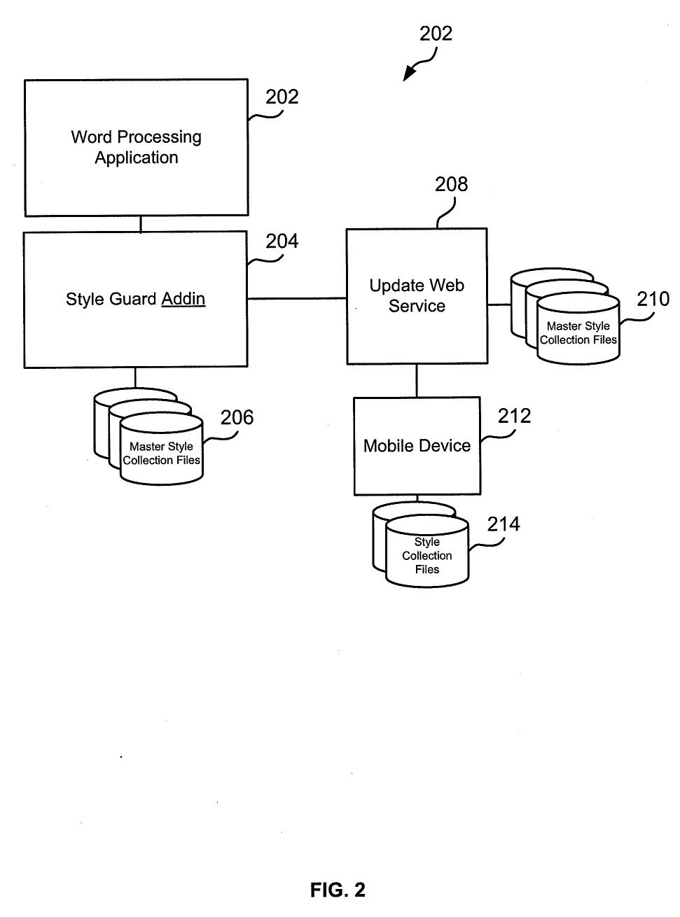

FIG. 2 shows an environment 200 in which various embodiments may be practiced. In an embodiment, the environment 200 includes a word processing application 202 to which a style guard add-in 204 has been installed. The style guard add-in 204 may access one or more data stores 206 having stored therein style collection files which will be described in more detail below. The word processing application 202, style guard add-in 204, and one or more data stores 206 may be implemented, for example, using the computer system described above in connection with FIG. 1. Returning to FIG. 2, the word processing application 202 in an embodiment is an application providing users the ability to create and/or modify content. A user may use the word processing application 202 in order to create and/or modify text, for example. Users may also use the word processing application 202 to create content other than or in addition to text such as pictures, audio, video, and generally any type of content. An example word processing application is Microsoft Word® provided by Microsoft Corporation, although other word processing applications may be used in accordance with various embodiments. In addition, embodiments of the present invention may be utilized in connection with other applications for creating content, such as spreadsheet applications, electronic mail applications, presentation applications, and, generally, any application with which rules may be checked against content.

Styles for a particular content-creating context may evolve over time for various reasons. Accordingly, the style guard add-in 204 may periodically query an update web service 208 in order to update locally stored style collection files so that the style collection files will reflect the latest style rules. In an embodiment, a style collection is a set of stylistic rules applicable in one or more contexts. Example stylistic rules include rules set forth by the Associated Press®, the International Organization for Standardization, various professional societies, and other organizations. As another example, stylistic rules may be set forth in various style manuals, such as the Bluebook®, The Chicago Manual of Style®, and others. A style collection file may include an encoding of one or more rules. For instance, a style collection file may be an extensible markup language (XML) file having elements, instances of which define conditions whose fulfillment indicates implication of a rule. Rules, in an embodiment, are encoded using regular expressions and/or JavaScript®.

As another example of use of the update web service 208, a user may, through user input, direct the style guard add-in 204 to request additional style collection files for other styles. A writer for instance may begin writing in a new context and therefore may utilize style guard add-in 204 to receive style collection files applicable to that context in accordance with an embodiment. A user may pay a fee in exchange for receipt of the new files and/or for updated files. When providing responses to requests for updates and/or new files, the update web service 208 in an embodiment accesses its own data stores 210 of style collection files. In an embodiment, the update web service 208 retrieves style collection files from the data store 210 according to any requests received and provides the retrieved files to the requestor.

In an embodiment, the users may utilize a mobile device 212 in order to check style. Mobile devices include, for example, smart phones, personal digital assistants, electronic book readers, cellular telephones, netbooks and generally any portable device with which content may be viewed, created and/or modified. A mobile device may utilize its own data store 214 which may have style collection files stored therein. Similar to the style guard add-in 204, a mobile device 212 may communicate with the update web service 208 in order to receive updated and/or new style collection files to ensure that style rules are current and applicable to any context in which a user of the mobile device 212 is working. It should be understood that the environment 200 is provided for the purpose of illustration and variations are possible. For example, embodiments of the present invention may be adapted for use in various environments, such as cloud environments where at least a portion of the logic used for implementing the embodiments is performed by machines other than those of the user.

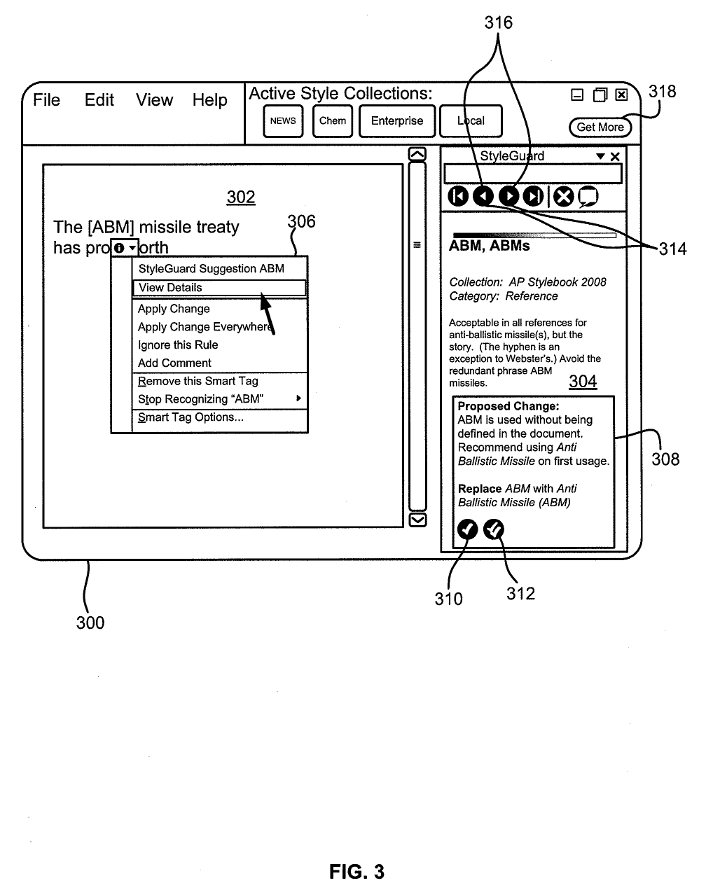

FIG. 3 shows an example interface page 300 in accordance with an embodiment. The interface page 300 may be provided by the word processing application 202 described above in connection with FIG. 2. The interface page 300 may include elements provided by the word processing application and elements provided from the style guard add-in 204. However, as discussed, various applications for creating content may utilize embodiments of the present invention and interface pages may vary accordingly. In an embodiment, the interface page 300 includes a document pane 302 in which content is displayed. The content may be, for example, text and/or other content input by the user using a suitable input device. In the example shown, the content “The ABM missile treaty has proven worth” is included in the document pane 302.

In an embodiment, the interface page 300 includes a style pane 304 to the right of the document pane 302, although the style pane 304 may be located in another location. In an embodiment, the style pane 304 includes information about one or more style rules that have been implicated by content of an open document. The style pane 304, in an embodiment, displays information and, if applicable, user options for an implicated style rule according to one or more criteria. The criteria may relate to user input indicative of interest in an implicated style rule. For example, text in the document pane 302 includes brackets around “ABM,” where the brackets indicate one or more style rules have been implicated by “ABM.” An information dropdown box 306 is displayed proximally to “ABM” and in an open state indicative of having been selected by the user. The dropdown box 306 in this example includes a plurality of selectable options available to the user. As shown, the user has selected with a cursor “View Details,” resulting in the display of information in the style pane 304.

The style pane 304 in this example includes information about one or more rules applicable to the string “ABM.” In this example, the string “ABM” (which represents “Anti-ballistic missle(s)”) in the content implicates at least two stylistic rules, the first mandating that the abbreviation “ABM” be defined in the document and the second being that the redundant word “missile” should not immediately follow “ABM.” As shown in the figure, information relating to the first implicated rule is shown.

In an embodiment, some rules may correspond to corrective actions that may be taken to correct stylistic violations. For instance, if the abbreviation “ABM” appears without definition, the first instance of “ABM” may be replaced with the string “anti-ballistic missile (ABM)” in order to correct the violation. A suggestion 308 describing the corrective action may appear in the style pane 304. If a rule has corresponding action(s) that may be taken for correcting stylistic violations, elements may be provided in connection with the style pane 304 to allow the user to direct that such action(s) be taken. In this example, a checkmark icon 310 and double checkmark icon 312 allow a user to direct that the corresponding action be taken in a particular instance of the rule's implication or direct that the corresponding corrective action be taken in all instances, respectively. As shown, other actions that may be taken in connection with an instance of a rule's implication may appear in the dropdown box 306. For rules that do not have corresponding corrective actions, such as rules that only provide information to the user when implicated, interface elements relating to actions that may be taken may not display. Example rules that do not have corresponding corrective actions include rules that merely provide information to a user when the rules are implicated.

Other features may also be provided. As noted, in this example, the string “ABM” in the content implicated at least two rules. In an embodiment, navigational controls are provided to allow a user to sequentially view information and options related to each implicated rules. The style pane 304, for instance, includes buttons 314 that allow a user to sequentially navigate back or forward to the previous or next implicated rule. Buttons 316 may allow navigation to the first or last implicated rule. Other features may include interface elements that, when selected by the user, cause rule implications to be ignored, allow the user to annotate the document by inserting a comment on the rule, allow the user to edit the rule, and the like.

In an embodiment, users may utilize rules for a plurality of different styles in connection with a single document. For instance, a user writing a news article for a chemistry-related news publication may wish to adhere to journalistic styles as well as styles for chemistry-related writing. Accordingly, in an embodiment, the interface page 300 provides elements that allow a user to select styles against which the content will be checked. In the upper right hand of the interface page 300, for example, icons corresponding to styles selected by the user appear. The selected styles in this example include “News,” “Chem,” (short for Chemistry), “Enterprise,” and “Local.” The Enterprise style may be a set of stylistic rules applicable to an organization. The Local style may be a set of rules applicable to a particular geographic region. A button 318 for obtaining additional styles may allow a user to cause additional rules to be downloaded or otherwise accessed.

In an embodiment, the rules of a particular style (news, chemistry, enterprise, local, etc.) are encoded in a style collection, which may include a plurality of styles. A style, in an embodiment, includes a plurality of rules, where each rule includes one or more conditions that, when fulfilled, indicate implication for the rule. Accordingly, in an embodiment, the active style collections shown in the interface page 300 correspond to sets of rules that are used to check the content. The following is an example of a style having several rules. In this example, the style applies to a style related to use of the string “ABM.”

<?xml version=“1.0” encoding=“UTF-8”?>
<Styles name=“My Styles” version=“1.0” logo=“logo.png” date=“10/16/2009 11:33 AM”>

<Style id=“7f3e13f7-17a9-4173-b774-a6b593eedefb” name=“ABM, ABMs”

category=“Reference” description=“Acceptable in all references for anti-ballistic missile(s), but
the term should be defined in the story. Avoid the redundant phrase ABM missiles. ”
importance=“6”>

<Link name=“Wikipedia” url=“http://en.wikipedia.org/wiki/ABM” img=“Wikipedia.png”

alttext=“Wikipedia” type=“Web” />

<Template id=“c4881fcb-fca9-43b0-9e57-76e00b29ed04” arg1=“ABM” arg2=“anti-ballistic

missile” />

<Rule id=“51a31c84-eb4a-4b74-a355-b2b44c6c4339” match=“\bABM missile\b”

suggest=“ABM” title“Avoid the redundant phrase ABM missiles. ” description=“Avoid the
redundant phrase ABM missiles. ” ignorecase=“True” order=“1” stopwhenmatched=“True”
scope=“Section” type=“RegularExpression” />

<Rule id=“d42345bc-0623-490c-8c7f-a572867b7a8f” match=“\babm\b” suggest=“ABM”

title=“Capitalize” description=“Capitalize” ignorecase=“False” order=“2”
stopwhenmatched=“True” scope=“Section” type=“RegularExpression” />

<Rule id=“804d49c7-7620-43bd-9fac-2e1f95f4a3de” match=“\bantiballistic\b” suggest=“anti-

ballistic” title=“The hyphen is an exception to Webster's.” description=“The hyphen is an
exception to Webster's.” ignorecase=“False” order=“3” stopwhenmatched=“False”
scope=“Section” type=“RegularExpression” />

</Style>
<StyleTemplate id=“c4881fcb-fca9-43b0-9e57-76e00b29ed04” name=“Abbreviation Template-

Para” description=“Used for abbreviations at para scope” arg1=“Abbreviation” arg2=“Full
Name”>

<Rule id=“4782f674-f20c-4b34-8796-012d405fe7bb” match=“var abbr =

&quot;{arg1}&quot;;&#xD;&#xA;var expanded = &quot;{arg2}&quot;;&#xD;&#xA;if
(wordDoc.indexOf(abbr) &gt;= 0 &amp;&amp; wordDoc.indexOf(expanded) == -
1)&#xD;&#xA; AddMatch(wordDoc.indexOf(abbr), abbr.length);&#xD;&#xA;&#xD;&#xA;”
suggest=“FixMatch(0, ‘{arg2}’);” title=“” description=“{arg1} is used without being defined in
the document. Recommend using &lt;i&gt;{arg2}&lt;/i&gt; on first usage.” ignorecase=“True”
order=“1” stopwhenmatched=“False” scope=“Section” type=“Javascript” />

<Rule id=“b90665d0-7d51-4cee-a35d-7a3885659f0f” match=“var abbr =

&quot;{arg1}&quot;;&#xD;&#xA;var expanded = &quot;{arg2}&quot;;&#xD;&#xA;if
(wordDoc.indexOf(abbr) &gt;= 0 &amp;&amp; wordDoc.indexOf(expanded) &gt;=0)
&#xD;&#xA;{&#xD;&#xA; if (wordDoc.indexOf(abbr) &lt;
wordDoc.indexOf(expanded))&#xD;&#xA; {&#xD;&#xA;
AddMatch(wordDoc.indexOf(abbr), abbr.length);&#xD;&#xA;
AddMatch(wordDoc.indexOf(expanded), expanded.length);&#xD;&#xA; }&#xD;&#xA;}”
suggest=“FixMatch(0, ‘{arg2}’);&#xD;&#xA;FixMatch(1, ‘{arg1}’);&#xD;&#xA;” title=“”
description=“Make sure you define {arg1} on first usage. In this document, the full form is
coming after usage.” ignorecase=“False” order=“2” stopwhenmatched=“False” scope=“Section”
type=“Javascript” />

<Rule id=“74afd8e0-b152-4f8d-9b91-030451348f8f” match=“var expanded =

&quot;{arg2}&quot;;&#xD;&#xA;if (wordDoc.indexOf(expanded) &gt;= 0)&#xD;&#xA; if
(wordDoc.indexOf(expanded) != wordDoc.lastIndexOf(expanded))&#xD;&#xA;
AddMatch(wordDoc.lastIndexOf(expanded), expanded.length);&#xD;&#xA;”
suggest=“FixMatch(0, ‘{arg1}’);” title=“” description=“{arg2} already exists in the document. It's
ok to use the abbreviation.” ignorecase=“False” order=“3” stopwhenmatched=“False”
scope=“Section” type=“Javascript” />

</StyleTemplate>

</Styles>

In an example style, information regarding the style is encoded in an XML file having a plurality of element instances. For instance, an instance of a <style> element includes attributes such as an identifier (id), name, category, and description that includes information about the ABM style. The <Style> element in this example includes a plurality of instances of sub-elements, including a <Link> element, a <Template> element, and a <Rule> element. The <Link> element instance, in an embodiment, includes information where more information about the style may be found. The <Link> element may include a hyperlink to a webpage related to the style. The <Template> element, in an embodiment, includes an “id” attribute which identifies a template into which information from “arg1” and “arg2” attributes may be inserted when the ABM style is invoked. In this example, the template appears as an instance of a <StyleTemplate> element of the XML file.

Instances of the <Style> element may include various attributes, such as a unique identifier for a corresponding style stored in an “id” attribute, a name for the style stored in a “name” attribute, a category stored in a “category” attribute, a description of the style in a “description” attribute, and the like. In an embodiment, instances of the <Style> element may include an “importance” attribute. In some instances, certain styles may be considered minor compared with other styles. When a rule of a style corresponding to a <Style> element instance is implicated, a visual indicator based on the numerical value in the “importance” attribute may be displayed to indicate to users the importance of the style. Numerical values in “importance” attributes may also be used in order to allow users to filter which rules are checked against content. Thus, a user, through his or her input, may specify that only rules having an “importance” attribute value greater than or equal to a certain value should be checked. In this manner, users may cause less important rules to be ignored.

Instances of the <Rule> element include attributes having information about the rules associated with the ABM style. For example, each <Rule> element includes an “id” attribute which includes a unique identifier for each rule. A “match” attribute includes an expression defining the conditions when a corresponding rule is implicated. In an embodiment, the “match” expression includes either a regular expression or a JavaScript expression, although other expressions may be used. As an example, “\bABM missle\b” is a regular expression that indicates that a corresponding rule is invoked when the redundant phrase “ABM missile” appears in content. As another example, “\b([0-9]+C\b” is a regular expression that would indicate that a corresponding rule is invoked when a number followed by “C” appears in content instead of the number followed by “degrees Celsius.” A “suggest” attribute includes information that indicates how a violation of a stylistic rule may be corrected. The “suggest” attribute may include a string that may replace another string, such as replacing “ABM missile” with “ABM.” Either the “match” or “suggest” attributes may also include expressions, such as JavaScript® expressions, defining how corrections should be made for matches. Expressions may include variables and may include programming logic.

A “title” attribute includes information about a corresponding rule, which may be a short statement that may be displayed to users to explain why the rule was invoked. Instances of the <Rule> element may also include a “description” attribute similar to the “title” attribute. An “ignorecase” attribute may include a Boolean value that, when true, indicates that evaluating whether the conditions for the rule are invoked should not take into account whether characters are capitalized. An “order” attribute may include a numeric value corresponding to the order in which a corresponding rule should be processed relative to other rules of the style. For example, a rule having an “order” attribute value set to 1 may be processed prior to a rule having an “order” attribute value set to 2. A “scope” attribute includes a value that indicates the scope of a corresponding rule. The value in a “scope” attribute indicates how much of the content should be checked in order to determine whether the conditions of a corresponding rule are met. For instance, the scope of a rule for avoiding use of the redundant phrase “ABM missile” may be smaller than the scope of a rule for avoiding use of the abbreviation “ABM” without having previously defined the abbreviation. In this example, determining whether ABM has been used without having previously defined the abbreviation may require the complete content of a document whereas determining whether “ABM missile” is used may require only analyzing a small portion of the document, such as a paragraph or even a sentence. Examples of values for “scope” attributes include “section,” “paragraph,” “document,” “sentence,” “word,” “character,” and others. Within a document, divisions of the content corresponding to a rule's scope may be indicated with metadata of the document or by any suitable method. However, in any particular embodiment, less or more values may be used. Scope values may also characterize the scope by length of content, such as a number of characters, words, paragraphs, and the like.

A “stopwhenmatched” attribute, in an embodiment, includes a Boolean value that indicates how implication of a corresponding rule affects other rules, such as other rules within the same instance of a <Style> element. In an embodiment, the value of a “stopwhenmatched” attribute being true indicates that, if the conditions of a corresponding rule are met, remaining rules of the same instance of the <Style> element are not checked. Likewise, the “stopwhenmatched” attribute being false indicates that the remaining rules should be checked, at least until the conditions are met of another rule within the same instance of the <Style> element having a “stopwhenmatched” attribute being true.

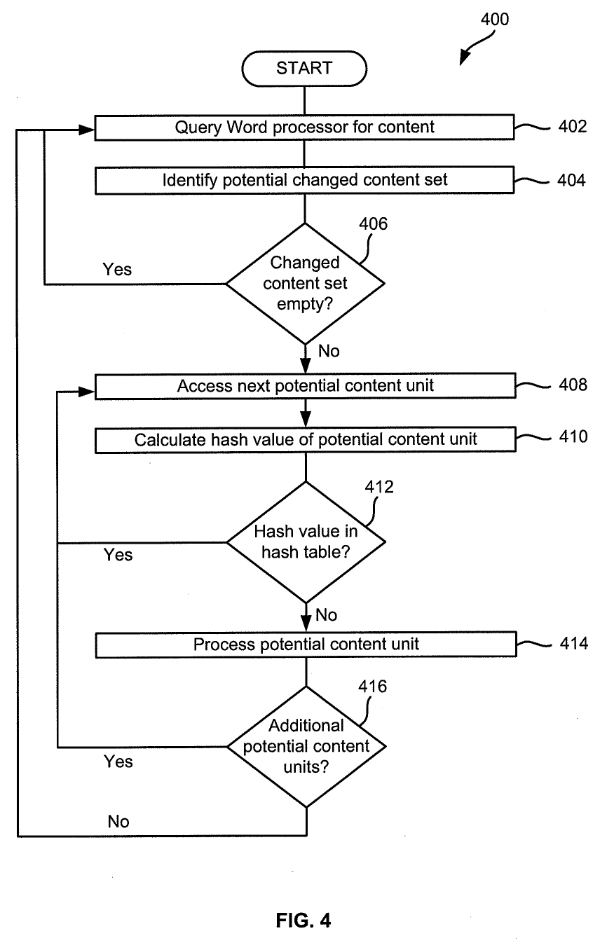

FIG. 4 shows a process 400 for checking content for implication and/or violation of style rules in accordance with an embodiment. The process 400 may be implemented on a computer system such as the computer system described above in connection with FIG. 1. In addition, instructions for causing a computer system to perform the process 400 or variations thereof may be stored on a computer-readable storage medium which may be non-transitory in time. In an embodiment, a word processor is queried 402 for content. Querying the word processor, may occur periodically such as every second or every two seconds. Querying the word processor may occur at other times, such as in response to detection of user input. The word processor may, in response to a query, provide content responsive to the query. Once the content is received, a potential set of the content that has changed is identified 404, in accordance with an embodiment. In an embodiment, the content includes text and identifying the potential changed content set includes comparing the content with a previously received version of the content to identify the first and last characters of the content that differ from the previous version. The potential changed content set in this example may include content between the identified characters.

It should be noted that, while, for the purpose of illustration, querying a word processor for content and identifying changes from that content are described in accordance with an embodiment, other processes for identifying changed content may be used. For example, the word processor (or other application) may provide to an application changed content in a manner that is not necessarily responsive to a query. Also, a word processor or other content-related application may perform style checking itself and, therefore, have direct access to changed content. Generally, any method of accessing changed content may be used. It should be noted that some or all of the changed content set is not necessarily changed. For example, insertion of content into a document may result in parts of the document moving locations within the document. In this instance, content that has not changed may be identified as part of the potential changed content set. Accordingly, measures may be taken in order to avoid processing of rules against all of the content in order to avoid unnecessary dedication of processing and memory resources. As described below, in an embodiment, potential content units of the potential changed content set are processed using a hash function in order to determine whether the potential content units have indeed changed. A content unit, in an embodiment, is a division of the content. In an embodiment, content units are paragraphs, although content units could be other divisions of content such as sentences, words, chapters, sections, strings of a certain length, or generally any divisions of content. Thus, in an embodiment, the potential changed content set includes a set of paragraphs. If the potential changed content set has been identified by detecting the first and last characters of the content that differ from a previous version, the potential changed content set may include the paragraphs in which the first and last characters that differ from the previous version are located.

In an embodiment, a determination is made 406 whether the changed content set is empty. If the changed content set is empty, the word processor is queried for content 402 once again, possibly after passage of some time, such as one second. Querying the word processor for content once again may be performed as soon as the determination is made whether the changed content set is empty, after a predetermined period of time, or otherwise. If the changed content set is not empty, in an embodiment, a next potential content unit is accessed 408. The next potential content unit may be the first potential content if no other potential content units have been accessed yet.

Once the next potential content unit is identified, a hash value of the potential content unit is calculated 410 in an embodiment. Calculating a hash value may include inputting the potential content unit into a hash function that outputs a hash value. Once a hash value of an identified potential content unit is calculated, in an embodiment, a determination is made 412 whether the calculated hash value is in a hash table maintained for the content. Existence of the hash value in the hash table may indicate that the identified potential content unit has already been checked for implication of applicable rules. Accordingly, if the has value is in the hash table, the next potential content unit is identified 408. However, if the hash value is not in the hash table 412, in an embodiment, the identified potential content unit is processed 414. Processing the potential content unit may involve, for example, determining whether one or more conditions of one or more style rules have been implicated and/or violated. Processing a potential content unit 414 may also include performing any actions specified for any rules that have been implicated. Once the potential content unit has been processed, a determination is made 416 whether there are additional potential content units of the identified changed content set. If there are additional potential content units, the next potential content unit is identified 408 in an embodiment. If there are no additional potential content units, in an embodiment, the word processor is queried 402 once again, either immediately, after a period of time, or otherwise. In this manner, the process 400 and/or portions thereof repeat themselves in order to take into account content that has been changed during processing of the content.

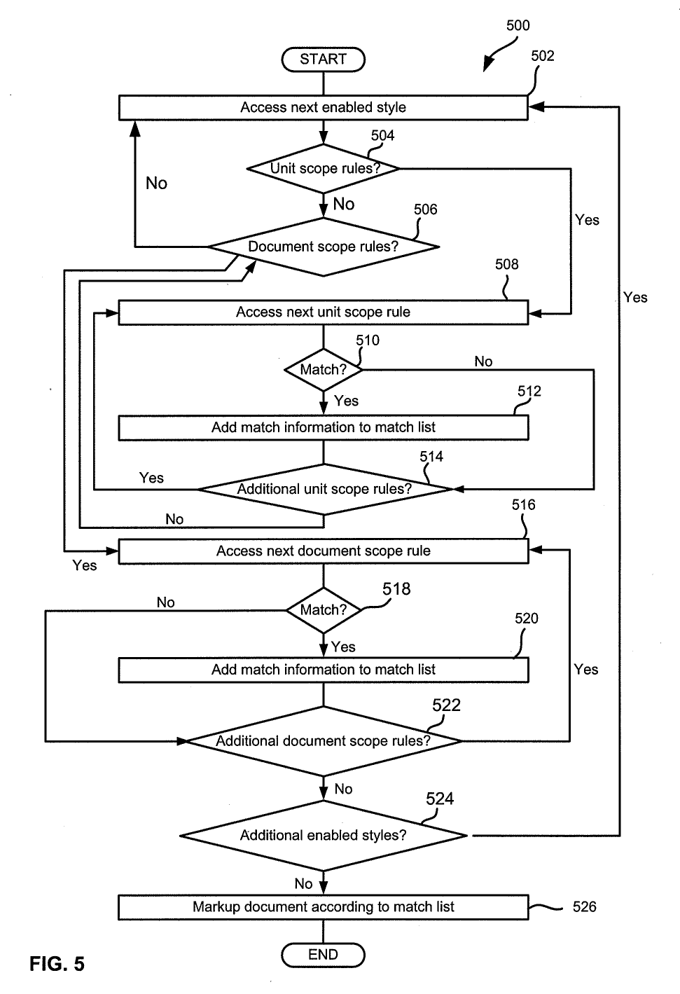

FIG. 5, in an embodiment, shows a process 500 for processing content units in accordance with an embodiment. The process 500, or variations thereof, may be used in connection with the processes 400 described above in connection with FIG. 4. As with the process 400 described above in connection with FIG. 4, the process 500 of FIG. 5 may be implemented using the computer system described above in connection with FIG. 1 and instructions for performing the method 500 or variations thereof may be stored on a computer-readable storage medium. In an embodiment, the process 500 includes accessing 502 the next enabled style. The next enabled style may be the first style if no other styles have been accessed. As used herein in connection with the description of the illustrative embodiment shown in FIG. 5, a style is a set of rules for checking against content. An enabled style, in an embodiment, is a style which a user, through user input, has indicated as being applicable to content being created by the user. Indication of an applicable style may be through user selection of a style collection, as described above.

In an embodiment, a determination is made 504 whether there are unit scope rules. A unit scope rule may be a rule which is applicable to a content unit. A unit scope rule may be a rule defined such that only content of a content unit being processed is used to determine whether conditions of the rule are met. In other words, a unit scope rule may be a rule in which information external to a content unit is unnecessary for determination whether conditions of the unit scope rule have been met. If there are no unit scope rules in the enabled style, a determination is made 506 whether there are any document scope rules. A document scope rule may be a rule for which content outside of content unit being processed may be used in order to determine whether the conditions of the rule are met. In other words, a rule may be a rule for which information external to a content unit, in some cases, is necessary for determining whether the rule is implicated. An example of a document scope rule is a rule with conditions that are met when an abbreviation is used without having been defined earlier in a document (because it may be desirable to define all definitions the first time they are used according to one or more conventions). Thus, in this example, for a particular paragraph having an abbreviation in it, other paragraphs previous to the paragraph with the abbreviation must be checked to determine whether the abbreviation has been defined.

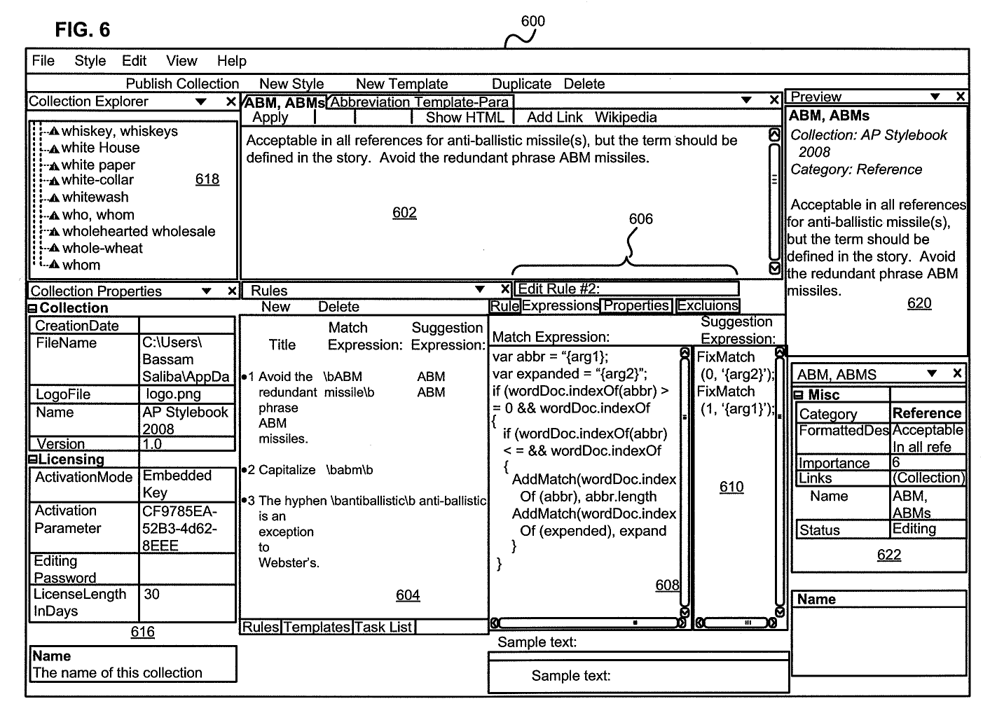

It should be noted that, while FIG. 5 shows determining whether there are any document scope rules for the purpose of illustration, other scopes may be utilized in addition to or as an alternative to document scope, such as chapter scope rules, section scope rules or generally any scope that is suitable for a particular context. For example, if there are no unit scope rules in the enabled style, a determination may be made whether there are any rules of scope greater than unit scope. For instance, if the unit scope is word scope, a determination may be made whether there are any rules of paragraph scope, page scope, section scope, chapter scope, document scope, document collection scope, and/or of other scopes. Scopes may also be user-defined, such as in connection with an interface similar to the interface shown in FIG. 6, described more completely below. Additionally, if a content unit currently being processed is part of a particular division of content (such as a user-defined section) a determination may be made whether there are any rules applicable to the division in which the content unit is located.

Returning to the illustrative example of FIG. 5, fit is determined that there are no document scope rules, then the next enabled style is accessed 502. Returning to the determination 504 whether there are unit scope rules, if there are unit scope rules then the next unit scope rule is accessed 508. The next unit scope rule may be the first unit scope rule in a set of unit scope rules. When the next unit scope rule is accessed 508, in an embodiment, a determination is made 510 whether there is a match. In an embodiment, a match occurs when conditions for the accessed unit scope rule are met by the content against which the conditions are being checked. Thus, when content of a content unit is being checked, a match occurs when the checked content unit meets conditions of the accessed unit scope rule. If there is a match, match information is added 512 to a match list. A match list may be a table that associates rule identifiers (such as values for the “id” attribute of instances of the <Rule> element, described above) with locations in the content where the content that met the conditions of the rule is located or it may be maintained as meta-data in the document, such as inside smart tags or other mechanisms. A match list may also be maintained as a separate attachment to a document whose content is being checked. In an embodiment, each entry in the list includes a rule identifier, a starting location (counted from the beginning of a document, paragraph, section, or other reference), and length of the content meeting the conditions. For instance, if the string “ABM” met the conditions for a rule, the length may be 3. If there is no match, a determination is made 514 whether there are additional unit scope rules and, if there are additional unit scope rules, the next unit scope rule is accessed 508. Also, the determination whether there are additional unit scope rules may be made upon adding the match information to the match list.

In an embodiment, if there are no additional unit scope rules for the enabled style, a determination is made 506 whether there are additional document scope rules for the enabled style. If there are additional document scope rules for the enabled style, the next document scope rule is accessed 516, in an embodiment. The next document scope rule may be the first document scope rule of a set of document scope rules. A determination is made 518 whether there is a match of the content to the accessed document scope rule. Determining whether there is a match may include checking the conditions of the currently accessed document scope rule against content that includes content external to a currently-processed content unit. For instance, if a currently accessed paragraph includes the string “ABM,” all content of the document prior to the currently processed content unit may be checked to determine whether a definition for ABM has been provided prior to the string. In an embodiment, if there is a match for the accessed document scope rule, match information is added 520 to the match list, such as in a manner described above.

Once the match information is added to the match list, in an embodiment, a determination is made 522 whether there are additional document scope rules. If there are additional document scope rules, the next document scope rule is accessed 514. If there are no additional document scope rules for the accessed enabled style, a determination is made 524 whether there are additional enabled styles. If there are additional enabled styles, the next enabled style is accessed 502, in accordance with an embodiment. If there are no additional enabled styles, the document may be marked up 526 according to the match list. Marking up the document may include visually distinguishing portions of the content related to implication of one or more rules. As discussed above, brackets may surround content related to implication of one or more rules. Underlining, highlighting, and/or other methods of distinguishing the portions of the content may be used.

Variations of the processes described in connection with FIGS. 5 and 6 are also contemplated within the spirit of the present disclosure. For instance, the process of claim 5 or variations thereof may be performed for a plurality of style collections. When processing of the process is complete, for example, a determination may be made if there are any additional enabled style collections and, if there are additional enabled style collections, the process may be repeated for the next enabled style collection. Additionally, the processes described herein may include more or fewer steps than explicitly described and steps shown in the drawings may, as appropriate, may be performed in a different order than shown. Additional steps, for instance, may be performed in order to improve efficiency. As described, for example, rules of a style may be defined such that, if conditions of one rule are met, then remaining rules of the style are ignored. As another example, styles may be defined with their own conditions such that, if the conditions are met, styles are ignored. Style collections, styles, rules, and the like may be organized differently than described herein in different embodiments. Also, certain steps may be performed simultaneously, such as in embodiments taking advantage of distributed processing, and some steps may be performed sequentially. Further, embodiments of the present disclosure.

In an embodiment, an interface for defining and modifying rules is provided. Users, for instance, may wish to create their own rules according to convention of an organization, personal preferences and the like. Accordingly, FIG. 6 in an embodiment shows an interface page 600 of an application for modifying and/or creating style rules in accordance with an embodiment. Rules created and/or modified using such an interface may be added to a data store in which rules are stored. For example, rules created and/or modified using such an interface may be stored in an XML file, such as an XML file having characteristics similar to the file discussed above. A computer system may use stored rules in order to check conditions of the rules against content, such as in a manner described above. In an embodiment, the interface page 600 includes a variety of the features and/or panes for various purposes. For instance, in the example shown, the interface page 600 includes a description pane 602 which includes a description of a rule currently being worked on by a user. The description in the description pane 602, for example, appears when the rule is implicated by content. Information in the description pane 602 may be based on a value of the “title” or “description” attributes of an XML file that encodes a corresponding rule, such as described above.

In an embodiment, the interface page 600 includes a rules pane 604 in which information directed to the various rules defined for a particular style is displayed. In the example interface page shown in the figure, a style entitled “ABM, ABMs” is being edited and, therefore, the rules in the rules pane 604 relate to conditions related to the string “ABM.” In an embodiment, users are able to edit rules using a rules editing pane 606. The rules editing pane 606, in this example, includes a match expression sub-pane 608 and a suggestion expression sub-pane 610. The match expression sub-pane 608, in an embodiment, provides a user the ability to enter and/or modify one or more conditions for a corresponding rule. In the example shown, conditions for rule number 2 of the rules pane 604 are shown. Expressions in the expression sub-pane 608 may be stored as values for a “match” attribute of the above-described XML file. The suggestion sub-pane 610, in an embodiment, may include an expression that is evaluated responsive to user input indicative of acceptance of a corresponding suggestion. For instance, if a user is suggested to replace “ABM” with “anti-ballistic missile (ABM),” and the user indicates through his or her input that he or she accepts the suggestions, an expression that, when evaluated, replaces “ABM” with “anti-ballistic missile (ABM)” may be evaluated. Such an expression may be inputted by a user into the suggestion sub-pane 610 and subsequently stored as a value of a “suggest” attribute of a corresponding XML file, as described above. Other features may be included in the rules editing pane 606. For example, users may be able to define conditions for exceptions to invocation of rules. Exceptions for a rule may include one or more conditions for the rule not being implicated despite other conditions for the rule being fulfilled. Users may be able to define properties of rules, such as by assigning importance values to rules, order values, and other values. Values assigned to the rules may be stored as attributes of element instances of an XML file as appropriate.

Other panes and features may also be included in an interface used for rules creation and modification. For instance, as shown in the figure, a collection properties pane 616 may display information about a collection of styles in which a rule or style is currently being edited. A collection explorer pane 618 may provide a list of styles in a particular collection such that users may view the styles and associated rules and edit as desired. A preview pane 620 may include a display equal to or similar to a display that would be displayed to a word processor (or other content-related application) if a rule was invoked by content entered by the user. A style information pane 622 may display and provide for editing of information about a currently accessed style. For example, users may assign an importance to a style currently being edited with the interface.

As another example of additional features, in an embodiment, users are provided access to rule templates for creating rules. A template may be a rule defined with variable portions such that a user may assign values to the variable portions in order to create a rule. In this manner, a plurality of similar rules may be easily created by users using a single template. As an example, users may want to create rules for abbreviations that are invoked when abbreviations that appear in a document are not previously defined in the document. The conditions for all such rules may be similar, with variations occurring in the abbreviations themselves and expressions that are suggested for replacing abbreviations. A user, therefore, in an embodiment, may utilize a template for such rules and simply input the abbreviations at issue and any expressions that should replace the abbreviations.

In addition, in an embodiment, templates are generated from user-created rules in order to provide users the ability to create similar rules. Creation of a template from a rule may include identifying objects (such as strings, numbers, and the like) of an expression of a rule and replacing the objects with variables. The expressions may be for defining conditions for matching and/or expressions for suggestions. Thus, for instance, if a user-created rule is based at least in part on a particular string, a new rule template may be generated that includes a variable in place of the particular string. Users then may utilize the template by assigning a value to the variable. Generation of templates may be done responsive to user input and/or automatically as a result of a rule being created.

In addition to the foregoing, rules may be created and used that have more complex (or simpler) conditions than the illustrative examples described herein. As an example, a rule may be invoked for any strings of capital letters of length more than one that appear in a document. Upon detection of such a string, a general suggestion to a user that a string appears to be an abbreviation may be displayed. As another example, strings representative of chemical symbols (such as H₂O) may invoke rules for such strings. Upon detection of a string corresponding to a chemical name, a display of a longer name for a chemical symbol may be displayed with an option to replace the symbol with the name. Generally, any conditions that may be checked against any content may be used for rules of various embodiments.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although embodiments of the present invention have been described using a particular series of transactions and steps, it should be apparent to those skilled in the art that the scope of the present invention is not limited to the described series of transactions and steps.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention.

What is claimed is:

1. A computer-implemented method of checking content, comprising:
under the control of one or more computer systems configured with executable instructions,
identifying a portion of the content that implicates a rule set, the rule set including one or more first rules having first scope and one or more second rules having second scope, the second scope being larger than the first scope;
for a first rule of the rule set, determining whether a first subset of the content meets one or more first conditions for the first rule, the first subset being in accordance with the first scope and including the portion;
for a second rule of the rule set, determining whether a second subset of the content meets one or more second conditions for the second rule, the second subset being in accordance with the second scope;
when the first subset meets the one or more first conditions, performing one or more first actions specified for the first rule; and
when the second subset meets the one or more second conditions, performing one or more second actions specified for the second rule.

2. The computer-implemented method of claim 1, wherein the first scope and second scope are each chosen from the group consisting of: character scope, word scope, paragraph scope, page scope, section scope, chapter scope, and document scope.

3. The computer-implemented method of claim 1, further comprising, identifying potentially changed portion of the content, and selecting the portion of the content that implicates the rule set from the potentially changed portion of the content.

4. The computer-implemented method of claim 2, wherein selecting the portion of the content that implicates the rule set includes, for each of one or more divisions of the potentially changed portion of the content,
calculating a hash value for the division; and
determining whether the hash value exists in a hash table.

5. The computer-implemented method of claim 1, further comprising repeating the method for a plurality of rule sets.

6. The computer-implemented method of claim 1, wherein the rule set includes at least one rule encoded by one or more regular expressions and at least one rule encoded in a scripting language.

7. The computer-implemented method of claim 1, further comprising:
receiving user input representative of a new rule; and
causing the new rule to be stored with the rule set.

8. A computer-readable storage medium having stored thereon instructions for causing one or more processors to check content for style, the instructions including at least:
instructions that cause the one or more processors to identify a portion of the content that implicates a rule set, the rule set including one or more first rules having first scope and one or more second rules having second scope, the second scope being larger than the first scope;
instructions that cause the one or more processors to, for a first rule of the rule set, determine whether a first subset of the content meets one or more first conditions for the first rule, the first subset being in accordance with the first scope and including the portion;
instructions that cause the one or more processors to, for a second rule of the rule set, determine whether a second subset of the content meets one or more second conditions for the second rule, the second subset being in accordance with the second scope;
instructions that cause the one or more processors to, when the first subset meets the one or more first conditions, perform one or more first actions specified for the first rule; and
instructions that cause the one or more processors to, when the second subset meets the one or more second conditions, perform one or more second actions specified for the second rule.

9. The computer-readable storage medium of claim 8, wherein the first scope and second scope are each chosen from the group consisting of: character scope, word scope, paragraph scope, page scope, section scope, chapter scope, and document scope.

10. The computer-readable storage medium of claim 8, wherein the instructions further comprise instructions that cause the one or more processors to identify potentially changed portion of the content, and select the portion of the content that implicates the rule set from the potentially changed portion of the content.

11. The computer-readable storage medium of claim 10, wherein the instructions that cause the one or more processors to select the portion of the content that implicates the rule set includes, for each of one or more divisions of the potentially changed portion of the content,
instructions that cause the one or more processors to calculate a hash value for the division; and
instructions that cause the one or more processors to determine whether the hash value exists in a hash table.

12. The computer-readable storage medium of claim 8, further comprising instructions that cause the one or more processors to repeat the method for a plurality of rule sets.

13. The computer-readable storage medium of claim 8, wherein the rule set includes at least one rule encoded by one or more regular expressions and at least one rule encoded in a scripting language.

14. The computer-readable storage medium of claim 8, wherein the content is stored in a document and wherein the instructions further include instructions that cause the one or more processors to maintain a match list in the document, the match list comprising information identifying one or more implicated rules.

15. A system for checking content for style, comprising:
a data store having stored therein a rule set that includes one or more first rules having first scope and one or more second rules having second scope, the second scope being larger than the first scope;
one or more processors communicatively coupled with the data store and operable to at least:
identify a portion of the content that implicates the rule set;
for a first rule of the rule set, determine whether a first subset of the content meets one or more first conditions for the first rule, the first subset being in accordance with the first scope and including the portion;
for a second rule of the rule set, determine whether a second subset of the content meets one or more second conditions for the second rule, the second subset being in accordance with the second scope;
when the first subset meets the one or more first conditions, perform one or more first actions specified for the first rule; and
when the second subset meets the one or more second conditions, perform one or more second actions specified for the second rule.

16. The system of claim 15, wherein the first scope and second scope are each chosen from the group consisting of: character scope, word scope, paragraph scope, page scope, section scope, chapter scope, and document scope.

17. The system of claim 15, wherein the one or more processors are further operable to identify potentially changed portion of the content, and select the portion of the content that implicates the rule set from the potentially changed portion of the content.

18. The system of claim 17, wherein the one or more processors are further operable to, for each of one or more divisions of the potentially changed portion of the content,
calculate a hash value for the division; and
determine whether the hash value exists in a hash table.

19. The system of claim 15, wherein the one or more processors are operable to repeat the method for a plurality of rule sets.

20. The system of claim 15, wherein the rule set includes at least one rule encoded by one or more regular expressions and at least one rule encoded in a scripting language.
